(19) United States
(12) Patent Application Publication
(10) Pub. No.: US 2019/0072039 A1
(43) Pub. Date: Mar. 7, 2019

(54) TURBOMACHINE WITH A PLANETARY GEAR APPLIANCE

(71) Applicant: Rolls-Royce Deutschland Ltd & Co KG, Blankenfelde-Mahlow (DE)

(72) Inventors: Winfried-Hagen FRIEDL, Berlin (DE); Daniel KICKENWEITZ, Berlin (DE); Gideon Daniel VENTER, Berlin (DE)

(21) Appl. No.: 16/115,213

(22) Filed: Aug. 28, 2018

(30) Foreign Application Priority Data
Sep. 1, 2017 (DE) 10 2017 120 219.6

(51) Int. Cl. F02C 7/36; F02C 3/06

(52) U.S. Cl. CPC F02C 7/36; F05D 2260/40311; F02C 3/06

(57) ABSTRACT

A turbomachine with a turbine device, a fan device and a compressor device, wherein the turbine device has a turbine shaft that acts together with a fan shaft of the fan device and a compressor shaft of the compressor device by means of a planetary gear device. The planetary gear device is embodied with a first shaft, a second shaft and a third shaft. The first shaft of the planetary gear device is connected to the turbine shaft of the turbine device in a torque-proof manner, the second shaft of the planetary gear device is connected to the fan shaft of the fan device in a torque-proof manner, and the third shaft of the planetary gear device is connected to the compressor shaft of the compressor device in a torque-proof manner. The planetary gear device has a fourth shaft that is fixedly attached to the housing.

This application claims priority to German Patent Application DE102017120219.6 filed Sep. 1, 2017, the entirety of which is incorporated by reference herein.

The invention relates to a turbomachine with a turbine device, a fan device, a compressor device and a planetary gear device according to the generic term as it is more closely defined in patent claim 1.

Jet engines with a turbine device and a blower or fan, in which the turbine device is directly connected to the fan and the fan rotates with the same rotational speed as the turbine device, in particular a low-pressure turbine, are well known in practice. In turbofan engines, which are also referred to as gear fan, and which have a high bypass ratio, the direct interdependence between the rotational speed of the fan and the rotational speed of the turbine is eliminated so as to be able to operate the fan as well as the turbine in optimal operating ranges. For example, noise reduction or a larger fan diameter requires a reduction of the fan's rotational speed, while the operating efficiency of the turbine can be improved by increasing the rotational speed while at the same time reducing the blade radius. The improved operating efficiency in turn offers the possibility of embodying the turbine with a lesser number of turbine stages, so that the turbine is characterized by a lower net weight and can be manufactured in a more cost-effective manner.

For resolving this conflict in goals regarding the rotational speeds, it is known to connect the turbine and the fan by means of a reduction gear in planetary design.

In embodiments as they are known from practice, a low-pressure compressor or so-called booster is connected to the low-pressure shaft in a torque-proof manner, so that it rotates with the same speed as the low-pressure shaft. In this way, unfavorable operating conditions may be present in the area of the low-pressure compressor depending on the operational state.

Further, it is known from WO 2013/151841 A1 to decouple the low-pressure compressor from the low-pressure turbine by means of a planetary gear in differential construction, wherein the planetary gear is also coupled to the fan. For example, the low-pressure turbine can be coupled to a planetary carrier of the planetary gear, the low-pressure compressor can be coupled to a sun wheel of the planetary gear, and the fan can be coupled to a hollow wheel of the planetary gear.

Since in this embodiment there is no fixed transmission ratio present between the low-pressure turbine, the low-pressure compressor and the fan during operation of the planetary gear, a high regulation complexity is necessary to ensure a desired distribution of the drive output of the low-pressure turbine to the low-pressure compressor and the fan in all operational states, and to operate the fan as well as the low-pressure compressor with a desired rotational speed.

In addition, such an embodiment may be problematic in the event of error cases in the area of the low-pressure compressor, since any blocking of the low-pressure compressor for example leads to a stronger rotational speed increase of the fan, and the latter has to be designed to be correspondingly strong to absorb the forces acting in the process.

The present invention is thus based on the objective of providing a turbomachine that is characterized by low installation space requirements and low component weight and that can be operated with a low regulation complexity.

According to the invention, this objective is achieved through a turbomachine with the features of patent claim 1.

What is proposed is a turbomachine, in particular a jet engine, with a turbine device, a fan device and a compressor device that is also referred to as a “booster”, wherein the turbine device has a turbine shaft which acts together with a fan shaft of the fan device and a compressor shaft of the compressor device by means of a planetary gear device or a planetary wheel set, wherein the planetary gear device is embodied with a first shaft, a second shaft and a third shaft, and wherein the first shaft of the planetary gear device is connected to the turbine shaft of the turbine device in a torque-proof manner, the second shaft of the planetary gear device is connected to the fan shaft of the fan device in a torque-proof manner, and the third shaft of the planetary gear device is connected to the compressor shaft of the compressor device in a torque-proof manner.

According to the invention, it is proposed that the planetary gear device has a fourth shaft that is fixedly attached to the housing, for example being connected to a fan housing.

Here, the term “shaft” is to be understood in the broadest sense as a coupling appliance and thus also includes a constructionally deactivated shaft.

A turbomachine embodied according to the invention has the advantage that, through a corresponding design, the compressor device and the fan can be operated in a desired rotational speed range without great regulation complexity. This makes it possible to keep the fuel consumption low, but also facilitates an embodiment with a low installation space requirement and low component weight. Due to the fact that a fixed rotational speed ratio is present between the turbine device and the fan for all operational states, the overall system can be better managed. Thus, in the event of a malfunction of the compressor device, e.g. in the event that a predetermined breaking point breaks following a blockade of the compressor device, a possible increase in the fan's rotational speed can for example be strongly reduced as compared to an embodiment of the planetary gear device in differential construction.

The embodiment of the turbomachine according to the invention further makes it possible to design an annulus or inner diameter of the compressor device independently of aerodynamics, wherein a larger inner diameter can be realized with the blade tip speed in the compressor device remaining the same. In other words, the booster or the compressor device can be radially enlarged or displaced radially outwards. This radial displacement in turn facilitates an at least partial placement of the planetary gear radially inside the compressor device, whereby a more axially compact design can be achieved. Through the larger inner diameter of the compressor device in connection with a lower rotational speed, the mechanical loads can also be reduced, and the result is a steeper inclination angle in the area of a hub of the fan, whereby the pressure created by the latter is increased.

The compressor device or the booster is preferably a low-pressure compressor or a medium-pressure compressor that is correspondingly connected to the low-pressure turbine shaft or the medium-pressure turbine shaft.

A high degree of efficiency can be achieved in a turbomachine according to the invention if the planetary gear device is embodied as a multi-step planetary gear.

In an advantageous embodiment of a turbomachine according to the invention, the fourth shaft comprises a planetary carrier of the planetary gear device, so that what is present is a so-called stationary planetary gear. Here, the rotational direction of a sun wheel and of a hollow wheel are opposed to each other.

The transmission between the turbine device and the compressor device can be adjusted in a broad range in a constructionally simple manner if the first shaft of the planetary gear device comprises a sun wheel, the second shaft of the planetary gear device comprises a hollow wheel, and the third shaft of the planetary gear device comprises a further sun wheel that is in operative connection with gear wheels that are connected to planets in a torque-proof manner. Here, the planets of the planetary gear device can in particular have two gear wheels, wherein a first gear wheel acts together or combs with the sun wheel as well as with the hollow wheel, and a second gear wheel acts together or combs with the further sun wheel.

In an advantageous further development of a turbomachine according to the invention, the planets of the planetary gear device have three gear wheels, wherein a first gear wheel of the planets acts together or combs with the sun wheel that forms the first shaft, a second gear wheel of the planets acts together or combs with the further sun wheel that forms the third shaft, and a third gear wheel of the planets acts together or combs with the hollow wheel that forms the second shaft. In this way, a very flexible adjustment of all transmission ratios between the turbine device, the compressor device and the fan device is possible in a broad range.

In an alternative embodiment of the invention, it is provided that the planets have three gear wheels, wherein a first gear wheel of the planets acts together or combs with the sun wheel that forms the first shaft, a second gear wheel of the planets acts together or combs with the further sun wheel forming the third shaft, and a third gear wheel of the planets acts together or combs with an additional sun wheel that forms the second shaft. In this way, an embodiment that saves installation space and is cost-effective becomes possible, with the fan device and the compressor device having the same rotational direction.

If the fourth shaft of the planetary gear device has a hollow wheel and thus an epicyclic planetary gear is present, high transmission ratios between the turbine device, the fan device and the compressor device can be achieved in a constructionally simple manner.

To create a turbomachine with an extension that is small in the longitudinal direction, it is advantageous to arrange the planetary gear device radially inside the compressor device at least in certain areas, and in particular completely, in the axial direction of the turbomachine. Here, the center of mass of the turbomachine can be advantageously shifted further back in the flow direction. If the turbomachine is connected to a wing of an aircraft as a jet engine, the projection of the jet engine from the wing in the direction of the aircraft's front can be reduced in this way, and the leverage during suspension of the engine at the aircraft wing is correspondingly reduced.

The features specified in the patent claims as well as the features specified in the following exemplary embodiments of the turbomachine according to the invention are suitable to further develop the subject matter according to the invention respectively on their own or in any desired combination with each other.

Further advantages and advantageous embodiments of the subject matter according to the invention follow from the patent claims and from the exemplary embodiments that are described in principle in the following by referring to the drawing, wherein, with a view to clarity, the same reference signs are used in the description of the exemplary embodiments for structural components having the same structure and functionality.

Herein:

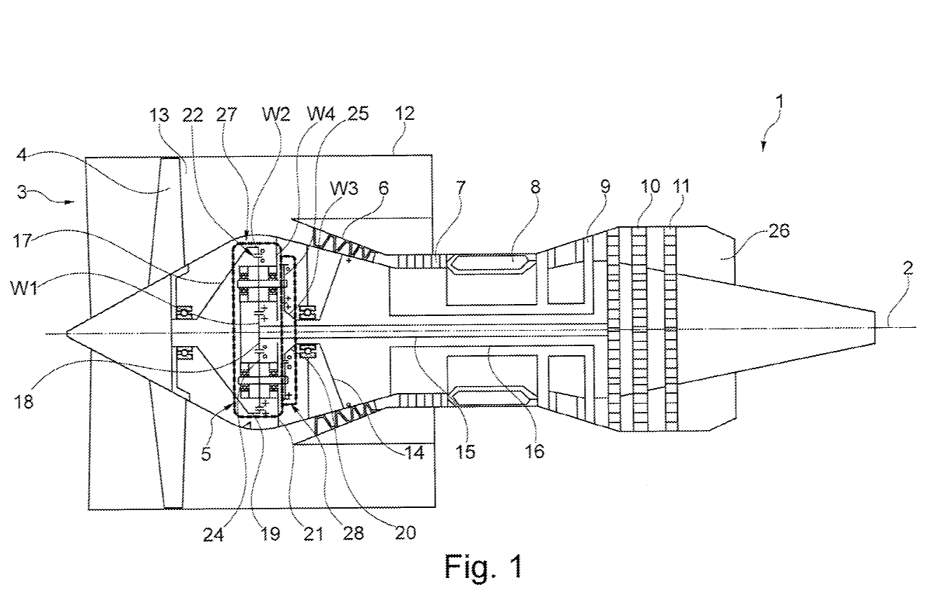

FIG. 1 shows a strongly simplified schematic sketch of a jet engine in longitudinal section, with a fan, a low-pressure turbine and a low-pressure compressor, wherein the fan and the low-pressure compressor are in operative connection with the low-pressure turbine my means of a planetary gear; and

FIGS. 2 to 4 shows simplified sectional views of a section of the jet engine according to FIG. 1, wherein the fan and the low-pressure compressor are connected to the low-pressure turbine my means of respectively alternatively embodied planetary gears.

FIG. 1 shows a turbomachine that is embodied as a jet engine 1 or gas turbine engine. The jet engine 1 has a main axis and a rotational axis 2. Further, the jet engine 1 comprises, in the axial flow direction, an air intake 3, a fan device or a blower 4 or fan, a planetary gear device 5, a compressor device embodied as a booster or low-pressure compressor 6, a high-pressure compressor 7, a combustion device 8, a high-pressure turbine 9 and a low-pressure turbine 11 as turbine devices and a discharge nozzle 26. An engine nacelle 12 surrounds the gas turbine engine 1 and delimits the air intake 3.

In principle, the jet engine 1 operates in the conventional manner of a turbofan engine, wherein air entering the intake 3 is accelerated by the fan 4 to create two air flows. A first air flow flows into the low-pressure compressor 6 and a second air flow is passed through a subsidiary flow channel or bypass channel 13 to provide a drive thrust. The low-pressure compressor 6 compresses the air flow that is supplied to it, before the air is further compressed in the area of the high-pressure compressor 7.

The compressed air that is discharged from the high-pressure compressor 7 is introduced into the combustion appliance 8, where an intermixing with fuel occurs, and the fuel-air mixture is combusted. The resulting hot combustion products expand and in doing so drive the high-pressure turbine 9 and the low-pressure turbine 11, before they are discharged via the discharge nozzle 26 to provide additional drive thrust. The high-pressure turbine 9 drives the high-pressure compressor 7 via the high-pressure shaft 16. The low-pressure turbine 11 is connected to a turbine shaft or low-pressure shaft 15, by means of which the fan 4 is driven via a planetary gear device 5 that represents a reduction gear.

The planetary gear device 5 that is embodied as a stationary planetary gear is embodied for transmitting torque from the low-pressure shaft 15 of the low-pressure turbine 11 to a fan shaft 17 of the fan 4 and a low-pressure compressor shaft 14 of the low-pressure compressor 6, wherein the fan 4 and the low-pressure compressor 6 respectively rotate with a different rotational speed than the low-pressure turbine 11. During operation, the fan 4 preferably rotates with a lower rotational speed than the low-pressure compressor 6, which in turn is preferably slower than the low-pressure turbine 11. In the embodiment according to FIG. 1, the low-pressure compressor 6 rotates in the same rotational direction as the low-pressure turbine 11, whereas the fan 4 rotates in an opposite direction thereto.

The planetary gear device 5 represents a multi-step planetary gear with an epicyclic gear unit 27 and a booster reduction gear transmission unit 28 or layshaft reduction, wherein the planetary gear device 5 is embodied with a first shaft W1, a second shaft W2, a third shaft W3, and a fourth shaft W4, of which the first shaft W1 is connected to the low-pressure shaft 15 and comprises a sun wheel 18, wherein the second shaft W2 is connected to the fan shaft 17 that drives the fan device 4 and comprises a hollow wheel 19. The third shaft W3 is connected to the low-pressure compressor shaft 14 and comprises a further sun wheel 20, wherein the fourth shaft W4 comprises a planetary carrier 21 which in the present case is attached to the engine nacelle 12 in a manner fixedly attached to the housing.

In the present case, the planets 22 of the planetary gear device 5, which are mounted so as to be rotatable with respect to the planetary carrier 21, have respectively two gear wheels 24, 25, of which the first gear wheel 24 combs with the sun wheel 18, on the one hand, and with the hollow wheel 19, on the other, and the second gear wheel 25 combs with the further sun wheel 20.

FIG. 2 to FIG. 4 show planetary gear devices 30, 40 and 50 that are embodied in an alternative manner to the planetary gear device 5, wherein only the differences of the planetary gear devices 30, 40, 50 with respect to the planetary gear device 5 are discussed in the following, and otherwise the embodiments of planetary gear device 5 are referred to.

In the planetary gear device 30 according to FIG. 2, the planets 22 respectively have three gear wheels 31, 32, 33, wherein the first gear wheel 31 combs only with the hollow wheel 19, the second gear wheel 32 combs only with the further sun wheel 20, and the third gear wheel 33 combs only with the sun wheel 18.

By choosing the diameters of the gear wheels 31, 32, 33 and of the sun wheel 18 that acts together with the same, the hollow wheel 19 and the further sun wheel 20 correspondingly, transmissions between the low-pressure turbine 11, the fan 4 and the low-pressure compressor 6 can be chosen in a simple manner within a broad range.

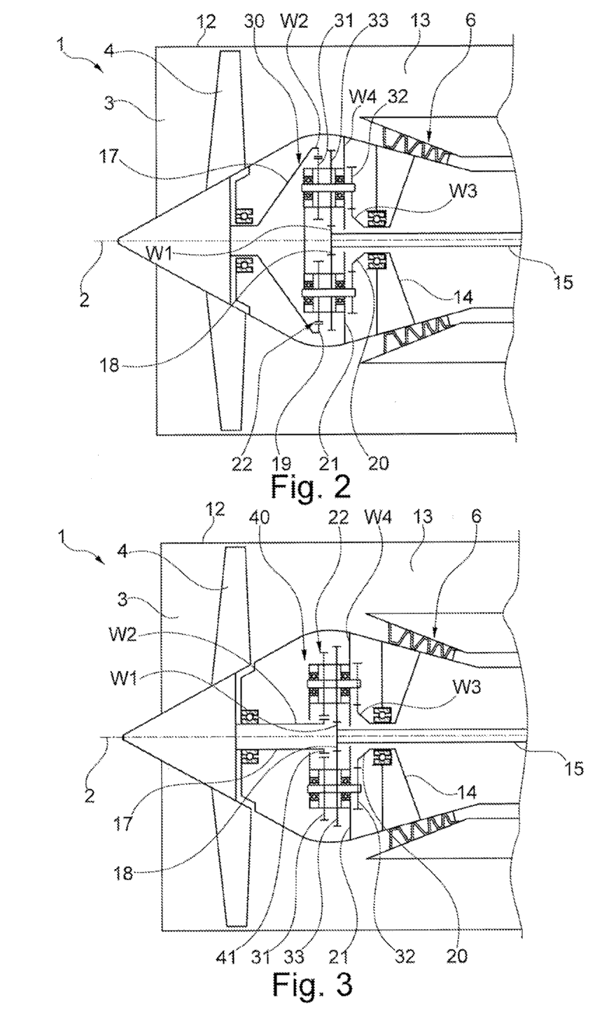

The planetary gear device 40 according to FIG. 3 differs from this only in that the first gear wheel 31 of the planets 22 is not in mesh with the hollow wheel 19, but with an additional sun wheel 41 that is connected to the fan shaft 17 and that is part of the second shaft W2, and that the planetary gear device 40 is embodied without a hollow wheel. A planetary gear device 40 that is embodied in such a manner can be realized in an installation-space saving and cost-effective manner.

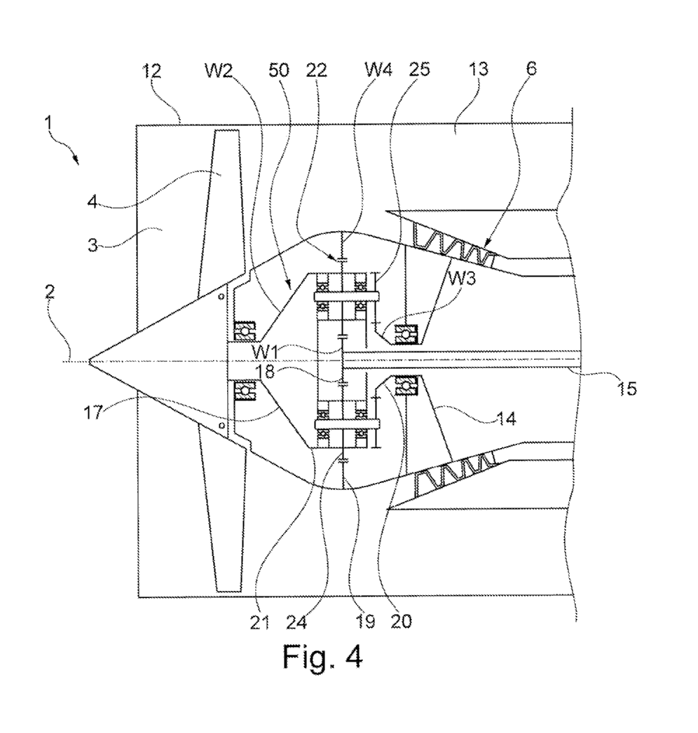

The planetary gear device 50 shown in FIG. 4 is again a multi-step planetary gear which is embodied as an epicyclic planetary gear. The first shaft W1 is connected to the low-pressure shaft 15 and comprises the sun wheel 18. The second shaft W2 is connected to the fan shaft 17 and comprises the planetary carrier 21. The third shaft W3 is connected to the low-pressure shaft 15 and comprises the further sun wheel 20, wherein the fourth shaft W4 comprises the planetary carrier 21 that is fixedly attached to the housing. In the present case, the planets 22 of the planetary gear device 5 again have respectively two gear wheels 24, 25, of which the one first gear wheel 24 combs with the sun wheel 18, on the one hand, and, on the other, with the hollow wheel 19, and the second gear wheel 25 combs with the further sun wheel 20.

With the embodiment of the planetary gear device 50, advantageously high transmission ratios between the low-pressure turbine 11, the low-pressure compressor 6 and the fan 4 can be achieved as compared to the embodiment of the planetary gear device as a stationary planetary gear.

In the shown exemplary embodiments, the fan 4 and the booster 6 are respectively coupled to the low-pressure turbine 11 by means of the planetary gear device.

### PARTS LIST

1 turbomachine; jet engine
2 rotational axis
3 air intake
4 fan device
5 planetary gear device
6 compressor device; low-pressure compressor (booster)
7 high-pressure compressor
8 combustion device
9 turbine device; high-pressure turbine
11 turbine device; low-pressure turbine
12 engine nacelle
13 bypass channel
14 low-pressure compressor shaft
15 low-pressure shaft
16 high-pressure shaft
17 fan shaft
18 sun wheel
19 hollow wheel
20 further sun wheel
21 planetary carrier
22 planet
24 first gear wheel
25 second gear wheel
26 discharge nozzle
27 epicyclic gear unit
28 booster reduction gear transmission unit
30 planetary gear device
31 first gear wheel
32 second gear wheel
33 third gear wheel
40 planetary gear device
41 additional sun wheel
50 planetary gear device
W1 first shaft
W2 second shaft
W3 third shaft
W4 fourth shaft

1. A turbomachine with a turbine device, a fan device and a compressor device, wherein the turbine device has a turbine shaft that acts together with a fan shaft of the fan device and a compressor shaft of the compressor device by means of a planetary gear device, wherein the planetary gear device is embodied with a first shaft, a second shaft and a third shaft, and wherein the first shaft of the planetary gear device is connected to the turbine shaft of the turbine device in a torque-proof manner, the second shaft of the planetary gear device is connected to the fan shaft of the fan device in a torque-proof manner, and the third shaft of the planetary gear device is connected to the compressor shaft of the compressor device in a torque-proof manner, wherein the planetary gear device has a fourth shaft that is fixedly attached to the housing.

2. The turbomachine according to claim 1, wherein the planetary gear device is a multi-step planetary gear.

3. The turbomachine according to claim 1, wherein the fourth shaft comprises a planetary carrier of the planetary gear device.

4. The turbomachine according to claim 1, wherein the first shaft of the planetary gear device comprises a sun wheel, the second shaft of the planetary gear device comprises a hollow wheel or a sun wheel, and the third shaft of the planetary gear device comprises a further sun wheel that is in operative connection with gear wheels which are connected in a torque-proof manner to planets of the planetary gear device.

5. The turbomachine according to claim 4, wherein the planets of the planetary gear device have three gear wheels, wherein a first gear wheel of the planets acts together with the sun wheel that forms the first shaft, a second gear wheel of the planets acts together with the further sun wheel that forms the third shaft, and a third gear wheel of the planets acts together with the hollow wheel that forms the second shaft.

6. The turbomachine according to claim 1, wherein the planets of the planetary gear device have three gear wheels, wherein a first gear wheel of the planets acts together with the sun wheel that forms the first shaft, a second gear wheel of the planets acts together with the further sun wheel that forms the third shaft, and a third gear wheel of the planets acts together with the additional sun wheel that forms the second shaft.

7. The turbomachine according to claim 1, wherein the fourth shaft of the planetary gear device comprises a hollow wheel.

8. The turbomachine according to claim 7, wherein the first shaft of the planetary gear device is a sun wheel, the second shaft of the planetary gear device is a planetary carrier, and the third shaft of the planetary gear device is a further sun wheel that acts together with gear wheels that are connected to the planets.

9. The turbomachine according to claim 1, wherein the planetary gear device is arranged at least in certain areas, and in particular completely, radially inside the compressor device in the axial direction of the turbomachine.
